(19) United States
(12) Patent Application Publication
(10) Pub. No.: US 2014/0096445 A1
(43) Pub. Date: Apr. 10, 2014

(54) METHOD OF CULTIVATION IN WATER DEFICIT CONDITIONS

(71) Applicants: Albert Bassi, Greensboro, NC (US); Daniel Perkins, Greensboro, NC (US)

(72) Inventors: Albert Bassi, Greensboro, NC (US); Daniel Perkins, Greensboro, NC (US)

(73) Assignee: SYNGENTA PARTICIPATIONS AG, Basel (CH)

(21) Appl. No.: 14/123,531

(22) PCT Filed: Jun. 1, 2012
(86) PCT No.: PCT/US12/40477

§ 371 Date: Dec. 3, 2013

Related U.S. Application Data
(60) Provisional application No. 61/493,413, filed on Jun. 3, 2011.

(51) Int. Cl. A01G 1/00

(52) U.S. Cl. CPC A01G 1/001
USPC 47/58.1 FV; 47/58.1 R

(57) ABSTRACT

The present invention provides a method of improving the yield or water use efficiency in crops of useful plants cultivated under deficit irrigation which comprises the application of an agrochemical compound to the plant, parts of such plant, plant propagation material, or at its locus of growth, wherein the agrochemical compound is selected from the strobilurins, the neonicotinoids, the azoles, the SAR-inducing compounds, certain plant growth regulators (PGRs) and mixtures of such compounds.

### FIELD OF THE INVENTION

The invention relates generally to a system and method for cultivating crops of useful plants and, more specifically, to a method for cultivating crop plants under deficit water conditions.

### BACKGROUND

It is common practice to irrigate crops in those regions where there is a shortage of rainfall to reduce yield risks associated with drought. Corn in particular is very sensitive to water stress. For example, the effect of water deficit on corn yield has been well documented over the years. Yield reductions due to water deficit periods can be as high as 46%, depending on when the deficit occurs during the crop season. Also, it is important to consider irrigation timing and other practices to mitigate the effects of water deficiency on yield. Conventional irrigation methods include flood irrigation, sprinkler irrigation and subsurface drip irrigation.

Agricultural intensification and population growth have increased the development of groundwater resources used for irrigation and other water needs. Irrigation withdrawals during the growing season that are needed to meet full irrigation demands, particularly in drought years, can create local drawdown problems for nearby users. Competition also has increased between irrigation, industrial, and municipal users of groundwater which has become an availability issue in some areas. In other areas, a state of overdraft exists due to the current rate of groundwater use which could eventually lead to depletion.

Both mandatory and voluntary water restrictions that stop or reduce irrigation for various periods of time have been proposed in order to ease water demand during peak use periods, to facilitate recharge and/or to reduce pumping costs. However, limiting water during critical crop growth stages can have disastrous results from both a yield and quality standpoint. More specifically, any savings from such water restrictions often are offset by even moderate crop yield losses. Additional economic losses will occur when such water restrictions affect grain quality. Moreover, economic multipliers due to revenue losses by cotton ginners, peanut shellers and grain handlers can also be calculated from such water restrictions. It would be desirable, therefore, to minimise these economic impacts occasioned by water use restrictions in agriculture.

One strategy to mitigate the impact of limited water availability is to use a deficit irrigation technique which utilizes less that the optimum quantity of water to produce a crop. Following deficit irrigation, water is applied during drought-sensitive growth stages of a crop. Outside these periods, irrigation is limited or even unnecessary if rainfall provides a minimum supply of water. Total irrigation application is therefore not proportional to irrigation requirements throughout the crop cycle. The aim of deficit irrigation is to stabilize yields and to obtain maximum crop water productivity rather than to maximize yields. Therefore, this technique will inevitably result in plant drought stress and consequently in production loss.

Another strategy which has been proposed to manage water mediated yield loss, particularly in dryland cropping system, is to use water-optimized or drought tolerant crop varieties in order to preserve yield in growing seasons when predicted rain fall is less than the expected seasonal water requirement for a conventional crop variety. However, appropriate water-optimized or drought tolerant varieties are not always available or economic.

Accordingly, there is a need for a system and method for increasing the (economic) yield in crops of useful plants that are cultivated under deficit water conditions. This technique can enable successful crop production with limited quantities of water when properly implemented and also provide framers with the means to reduce the need for irrigation in a normal-rain growing season and in dry years.

### SUMMARY OF THE INVENTION

In accordance with the present invention, it has now been discovered that the application of certain agrochemical compounds to crops of useful plants will improve yield and/or water use efficiency when such crops are cultivated under managed water deficit conditions either throughout a growing season or during one or more discrete crop growth stages that occur at some point during a growing season. The water deficit conditions employed in the inventive method are measured relative to a full expected seasonal water requirement for such crop or relative to the optimal amount of water required by such crop at a well determined growth stage interval(s). Suitable agrochemicals are those selected from the strobilurins, the neonicotinoids, the azoles, the SAR-inducing compounds and certain plant growth regulators (PGRs) and mixtures of such compounds. Water deficit conditions may be managed through irrigation, dry land cultivation based on historical and/or seasonal rainfall predictions, or combinations thereof.

### DETAILED DESCRIPTION

More specifically, the present invention provides a method of improving the yield and/or increasing water use efficiency (or irrigation water use efficiency) in crops of useful plants that are managed for water-deficit conditions during a growth period comprising the steps of:

a) determining either an expected seasonal non-deficit water requirement for the crop or an expected non-deficit water requirement for one or more discrete growth stages of the crop;

b) maintaining the crop available water (such as the available soil water) at an average of from 40 to 80% of: i) the expected seasonal water requirement during the total growing period or ii) the expected water requirement for said one or more discrete growth stages of the crop;

c) applying to the plant, parts of such plant, plant propagation material, or at its locus of growth, a yield and/or water use efficiency improving effective amount of a compound selected from strobilurins such as azoxystrobin, neonicotinoids such as thiamethoxam, azole or conazole fungicides such as propiconazole, SAR-inducing compounds such as acibenzolar-S-methyl and PGRs such as paclobutrazole and trinexapac-ethyl. In one embodiment, the compound(s) is applied to the soil, to the foliage or is applied in the irrigation water (chemigation).

In one embodiment, the present invention provides a method of improving the yield and/or increasing the water use efficiency in crops of useful plants that are managed for water-deficit conditions during a growth period. In accordance with the method of the invention, a growth period can be the whole growing season (total growing period) or a discrete crop growth stage. When the growth period is the whole growing season, the water-deficit conditions are measured relative to the expected total amount of water which the crop typically would requires over the whole growing season. When the growth period is one or more discrete growth stages during the growing season, the water-deficit conditions are measured relative to the optimal amount of water required by the crop during such growth stage(s) being managed for water-deficit cultivation and/or irrigation.

In accordance with one embodiment of the invention, water-deficit conditions are achieved by maintaining the crop available water at an average of from 40 to 80%, more particularly from 50 to 75%, of the expected water requirement for such crop during a crop growing period or periods being managed. While maintaining the deficit conditions, a yield and/or water use efficiency improving effective amount of a compound selected from the strobilurins such as azoxystrobin, the neonicotinoids such as thiamethoxam, the azoles or conazoles such as propiconazole, the SAR-inducing compounds such as acibenzolar-S-methyl and the PGRs such as paclobutrazole and trinexapac-ethyl (or mixtures thereof), is applied to the plant, parts of such plant, plant propagation material, or at the locus of plant growth (such as the soil or the like).

According to an aspect of the present invention, suitable crop growing periods to be managed for water-deficit conditions include (1) the entire growing season for the crop, (2) one or more vegetative growth period(s), (3) one or more reproductive growth periods such as tasseling or flowering, and grain fill or seeding, and (4) various combinations of periods (2) and (3). Using corn as an example, one or more growth stages or periods are selected from vegetative stages such as V1, V2, V3, V4, V5, V6, V7, V8, V9, V10 . . . V(n) (where n is the nth fully expanded leaf with the leaf collar), and reproductive stages including VT (tasseling) and R1 (grain fill). Using soya as an example, one or more growth stages are selected from vegetative stages V1, V2, V3 . . . V(n) (nth trifoliate), reproductive stages including flowering, such as R1 and R2, pod formation such as R3 and R4 and seed formation such as R5-R8.

As used herein, water-deficit or water-limited conditions refer to water conditions which would be considered less than optimum or preferred as the water requirement for providing a maximum economic yield based on conventional methods prior to the disclosure of the present invention. Skilled persons will appreciate that the optimal seasonal water requirement (or requirement for various growth stages) will vary depending on various factors including crop, variety, and environmental conditions such as light, moisture, and nutrient levels.

By way of example, the expected seasonal water requirement for a particular crop may be determined by methods known in the art such as procedures given generally in FAO Guidelines for predicting crop water requirements. (See, e.g., Doorenbos, J. and A. K. Assam. 1979. Yield response to water. Irrigation and Drainage Paper 33. FAO, United Nations, Rome, p. 176.) Likewise, the water requirement for a crop during either an entire growing season or the optimal amount of water required by a crop during one or more discrete growth stages during a growing period can be determined, for example, by known methods (see, e.g., Critchley W., Siegert K. and Chapman C., “Water Harvesting” FAO—Rome 1991, in particular section 2.1 “Water requirements of crops” and documents cited therein. See also http://www.fao.org/docrep/U3160E/U3160E00.htm). (The Doorenbos et al and Critchley et al references are incorporated by reference herein.)

In accordance with an embodiment of the invention, water deficit conditions are those wherein the available water, such as, for example, available soil water, for a particular crop or plant is maintained at an average of from 40 to 80%, more particularly from 50 to 75%, of the expected seasonal requirement for such crop or plant during the total growing period/season or the expected water requirement for such crop during one or more discrete growth stages being managed for water deficit conditions at some point during the total growing period.

In one embodiment, water-deficit conditions are maintained by cultivating a crop or plant under deficit irrigation or by irrigation scheduling.

In another embodiment, water-limited conditions are maintained by cultivation of the crop or plant in a marginal soil having a water holding capacity or plant available soil water at an average of from 40 to 80%, more particularly from 50 to 75%, of an expected seasonal water requirement for such crop, or the expected water requirement for such crop during one or more discrete growth stages) (such as sandy textured soils or clay soils, for example).

In a further embodiment, water-deficit conditions are maintained by dryland/rainfed cultivation of a crop in a region where an average of from 40 to 80%, more particularly from 50 to 75%, of the expected seasonal water requirement of such crop (or the expected water requirement for such crop during one or more discrete growth stages) based on historical and/or seasonal rainfall predictions.

In another aspect, water deficit conditions are maintained by increasing the planting density for a crop in order to reduce the average available soil water per plant to within 40 to 80%, more particularly from 50 to 75%, of the expected seasonal requirement for such plant or a crop of such plant (or the expected water requirement for such crop during one or more discrete growth stages). For example, by providing plants at a density at least 10% greater than plant density considered optimal or normally recommended by agronomic experts for such crop plant.

Suitable agrochemical compounds that are employed in accordance with the present invention include the strobilurins, the neonicotinoids, the azole fungicides, SAR-inducing compounds and certain plant growth regulators. The most suitable agrochemical compounds employed in the practice of this invention are selected from azoxystrobin, thiamethoxam, propiconazole, paclobutrazole, acibenzolar-S-methyl and trinexapac-ethyl, or mixtures of such compounds.

Among the suitable mixtures for corn there may be mentioned, azoxystrobin and propiconazole; azoxystrobin and trinexapac-ethyl; and azoxystrobin, propiconazole and trinexapac-ethyl.

Among the suitable mixtures for soya there may be mentioned, azoxystrobin and acibenzolar-S-methyl.

The agrochemical compounds can be applied, for example, in a single “ready-mix” form, in a combined spray mixture composed from separate formulations of the single active ingredient components, such as a “tank-mix”, or as a single active ingredient applied in a sequential manner, i.e. one after the other within a period of time up to 21 days.

The agrochemical compounds may be formulated and applied to the crop using conventional methods including soil application, foliar application and application in the plant irrigation water. Where simultaneous application is performed, supplying the agrochemical compounds in the form of a twin pack or mixture may be preferred.

The application rates of agrochemical compounds are generally no more than those used on current product labels containing such agrochemicals for similar crops, controlling for geographic and climactic conditions, crop density, and application method. Lower rates may be employed.

For example, typical rates of application are normally from 1 g to 2 kg of active ingredient (a.i.) per hectare (ha), suitably from 5 g to 1 kg a.i./ha, more suitably from 20 g to 600 g a.i./ha, yet more suitably from 50 g to 200 g a.i./ha. In one embodiment, the rate of application of the strobilurins, the neonicotinoids, the azole/conazole fungicides, and certain plant growth regulators is 50 g to 200 g/ha, and the rate of application of the SAR-inducing compounds is from 5 g to 50 g/ha.

In one embodiment, suitable rates and application timings for the agrochemicals used in the inventive methods are comparable to the existing rates and timings given on the current product labels for products containing such agrochemicals such as azoxystrobin (Quadris®), paclobutrazol (Trimmit®), trinexapac-ethyl (Moddus®), propiconazole (Tilt®), acibenzolar-S-methyl (Actigard®) and thiamethoxam (Actara®).

The term “improving yield” of a plant means that the yield of a product of the plant is increased by a measurable amount over the yield of the same product of the plant produced under the same water conditions, but without the application of the agrochemical compounds according to the present invention. In one embodiment, increased yield includes increased total number of seeds or grain, increased number of filled seeds or grain, increased total seed or grain yield, increased root length or increased root diameter, each relative to a corresponding control plant grown under optimal water conditions. In one embodiment, it is suitable that the yield is increased by at least about 0.5%, suitably 1%, more suitably 2%, yet more suitably 4% or more.

When reference is made to water use efficiency (WUE), this also includes terms known in the art such as crop water use efficiency (CWUE), irrigation water use efficiency (IWUE) and water productivity (WP). For example, in one aspect, WUE=Yield/Evapotranspiration; or mass of grain/water volume); or (irrigated yield−rainfed yield)/(Evapotranspriation or total irrigation applied. Viets, 1962, defined WUE as the ratio of crop yield (usually economic yield) to the amount of water used to produce the crop. WUE or WP may be determined by methods known in the art such as procedures given generally in Payero et al. Agricultural Water Management 95 (2008) 895-908 which is incorporated by reference herein.

In one embodiment, the agrochemical compound is applied in accordance with the present invention at one or more growth stages including both vegetative and reproductive stages. In a specific embodiment, the agrochemical is applied at a late vegetative-early reproductive stage such as the corn V5 (or higher) to R1 stages.

In accordance with the invention, a soil selected from clay, clay loam, loam, loamy sand, sand, sandy clay, sandy clay loam, silt, silty clay, silty clay loam and silt loam may be used to cultivate the crops in accordance with the method of the invention

Water deficit conditions can be maintained in whole or in part by deficit irrigation or irrigation scheduling. This can be achieved by any suitable irrigation method, which also ensures that the one or more agrochemicals penetrate the soil or absorbed by the plant, for example, localised irrigation, spray irrigation, drip irrigation, bubbler irrigation, sub-soil irrigation, soil injection, seepage irrigation, surface irrigation, flooding, furrow, drench, application through sprinklers, micro-sprinklers or central pivot, or manual irrigation, or any combination thereof.

In one embodiment, the agrochemical compound is applied along with the irrigation water. In a specific embodiment, there may be mentioned sprinkler, subsurface drip and surface drip irrigation.

For ease of description, the present invention is disclosed using embodiments related to maize. However, it is contemplated that the invention could be used on a variety of commercial crops. For example, leguminous plants, such as soybeans, beans, lentils or peas; oil plants, such as sunflowers, rape, mustard, poppy or castor oil plants; sugar cane; cotton. Useful plants of elevated interest in connection with present invention include crops and useful plants such as soybean, maize, rice, beans, peas, sunflower, oil seed rape, sugar cane, cotton, vegetables, turf, ornamentals, and wheat. In particular, the method of the invention can be applied to crops of useful plants including field crops such as corn and soybean. This list does not represent any limitation.

Crops are to be understood as also including those crops which have been rendered tolerant to herbicides or classes of herbicides (e.g. ALS-, GS-, EPSPS-, PPO-, ACCase and HPPD-inhibitors) by conventional methods of breeding or by genetic engineering. Examples of crops that have been rendered tolerant to herbicides by genetic engineering methods include, e.g. glyphosate- and glufosinate-resistant maize varieties commercially available under the trade names RoundupReady® and LibertyLink®.

Crops are also to be understood as being those which have been rendered resistant to harmful insects by genetic engineering methods, for example Bt maize (resistant to European corn borer). Examples of Bt maize are the Bt 176 maize hybrids of NK® (Syngenta Seeds). The Bt toxin is a protein that is formed naturally by Bacillus thuringiensis soil bacteria. Examples of toxins, or transgenic plants able to synthesise such toxins, are described in EP-A-451 878, EP-A-374 753, WO 93/07278, WO 95/34656, WO 03/052073 and EP-A-427 529. Examples of transgenic plants comprising one or more genes that code for an insecticidal resistance and express one or more toxins are KnockOut® (maize), Yield Gard® (maize), NuCOTIN33 B® (cotton), Bollgard® (cotton), Agrisure Viptera™ 3111 (corn). Plant crops or seed material thereof can be both resistant to herbicides and, at the same time, resistant to insect feeding (“stacked” transgenic events). For example, seed can have the ability to express an insecticidal Cry3 and/or VIP protein while at the same time being tolerant to glyphosate.

For example, glyphosate-tolerant plants are widely available as are plants modified to provide one or more traits such as drought tolerance or pest resistance. One example of a hybrid or transgenic plant is MIR604 Maize from Syngenta Seeds SAS, Chemin de l'Hobit 27, F-31 790 St. Sauveur, France, registration number C/FR/96/05/10, which has been rendered insect-resistant by transgenic expression of a modified CryIIIA toxin and may be used according to the present invention.

Crops are also to be understood to include those which are obtained by conventional methods of breeding or genetic engineering and contain so-called output traits and quality traits (e.g. improved storage stability, higher nutritional value, improved flavour of the grain as well as transgenic or native traited crops having enhanced tolerance to abiotic stresses such as drought stress or heat stress—Agrisure Artesian, for example).

For example, many crop plants develop through vegetative stages followed by reproductive stages. Some crop plants develop through ripening stages after their reproductive stages. In the practice of the present invention, crop plants are contacted with a composition of the present invention one or more times during one or more reproductive or vegetative stages. In some embodiments, crop plants may optionally be additionally contacted with a composition of the present invention one or more times prior to any reproductive stage, one or more times during any ripening stage, or a combination thereof.

In the practice of the invention, the agrochemical compounds may be applied in the form of dusts, granules, solutions, emulsions, wettable powders, flowables and suspensions. More particularly, suitable formulation types include an emulsion concentrate (EC), a suspension concentrate (SC), a suspo-emulsion (SE), a capsule suspension (CS), a water dispersible granule (WG), an emulsifiable granule (EG), an emulsion, water in oil (EO), an emulsion, oil in water (EW), a micro-emulsion (ME), an oil dispersion (OD), an oil miscible flowable (OF), an oil miscible liquid (OL), a soluble concentrate (SL), an ultra-low volume suspension (SU), an ultra-low volume liquid (UL), a technical concentrate (TK), a dispersible concentrate (DC), a wettable powder, a soluble granule (SG) or any technically feasible formulation in combination with agriculturally acceptable adjuvants.

Application of a compound as an active ingredient is made according to conventional procedure to the locus of the plant in need of the same using the appropriate amount of the agrochemical compound to achieve the desired effect (yield and/or WUE under water deficit conditions). According to the present invention the application of the compound to the “locus” of the plant includes application to the soil, to the plant or to parts of the plant. Application of suitable agrochemical compounds via chemigation also is contemplated.

In the practice of the method of the invention, the agrochemical compounds useful in the inventive method may also be applied in conjunction with other ingredients or adjuvants commonly employed in the art. Examples of such ingredients include drift control agents, defoaming agents, preservatives, surfactants, fertilizers, phytotoxicants, herbicides, insecticides, fungicides, wetting agents, adherents, nematocides, bactericides, trace elements, synergists, antidotes, mixtures thereof and other such adjuvants and ingredients well known in the plant growth regulating art.

The invention also relates to harvestable parts of the plant obtained by the method according to the present invention.

The invention further relates to products derived from the plant or from harvestable parts of said plant obtained by the method according to the invention.

The following examples are presented to illustrate the efficacy of the method of invention, and the conditions under which the invention may be used.

### EXAMPLES

### Examples 1-2

Testing Procedure: A chemigation study using Subsurface Drip Irrigation (SDI) was conducted to quantify the impact of treatment effects on grain yield, evapotranspiration, and water use efficiency of corn under limited (deficit) and fully-irrigated setting. Drip lines were placed 15-20 inches below the soil surface in row middles to maintain the proper soil wetting pattern. Irrigation control panels, chemical injection pumps, and filters were housed at the irrigation well house to manage irrigation and chemigation events. The field study was set up as a randomized complete plot design (split plot) with three replications on silt loam soil. Each plot was 8 rows wide (6.1 meters) by 34 meters long. Soil water status was monitored on an hourly basis every 30 cm up to 1.2 meters throughout the growing season using soil moisture sensors. Corn seed was planted with a precision planter at a depth of 2 inches and rows spaced at 30 inches. The planting population was 30,000 seeds per acre. Testing parameters, irrigation levels, and harvesting were conducted according to the University of Nebraska experimental procedure (see, e.g.,: Irmak, S, D. Z. Haman, and R. Bastug. Determination of Crop Water Stress Index for irrigation Timing and Yield Estimation of Corn. 2000. Agronomy Journal. 92:1221-1227). Moisture levels, irrigation levels, evapotranspiration, and plant health were measured throughout the growing season. All microclimatic variables were measured (air temperature, rainfall, solar and net radiation, relative humidity, rainfall, wind speed and direction) so that the researcher could quantify the range of the microclimatic conditions under which this research was conducted to define the boundaries of experimental conditions.

Field management consisted of three irrigation treatments: 100% ETc, 50% ETc, and rainfed (ETc=actual crop evapotranspiration). Irrigations applied usually two times a week with a 0.5 inch application rate in each irrigation event. No irrigation applied when rainfall exceeded plant water requirement. Irrigation trigger point is based on pre-determined soil water depletion level (when the average top 2 sensors read 80-90 kPa). A total of 6.5 inch of irrigation applied to the 100% ETc, 3.3 inch to 50% ETc treatment (deficit irrigation), and no irrigation on rainfed plots. Fertility management included 190 lbs/acre of 28% UAN was applied early season. Maintenance crop protection products were applied as needed to manage weeds and pests throughout the season for all treatments including the control. Azoxystrobin (Quadris) was applied twice via drip irrigation at a rate of 0.8 fl. oz/1000 linear ft (261 gai/ha) or by foliar application (tractor mounted sprayer) at 14 fl. oz./acre (261 gai/ha) at approximately the V8 & V8+14da. stage of the corn. Crop yield from each replication was recorded after harvest and adjusted to 15.5% moisture content. The researcher developed ETc vs. yield relationships (crop water production functions) for different treatments to evaluate the product impact on these functions. Quantified crop water use efficiency (CWUE) from ETc, dryland yield, and irrigated yield data was calculated to evaluate the product impact on CWUE.

Results: Definitive results were found with Quadris (Azoxystrobin) providing yield increases and favourable WUE in a water-deficit situation (Table 1). By reducing water by 50% (water deficit) and applying Quadris via subsurface drip irrigation (SDI), we can increase irrigated water use efficiency by 114% relative to the Control at 100% irrigated.

NOTE: a % increase value of 0% or better shows good activity since the treatment is either equal to or better than the Control using 50% less water.

TABLE 1

| Treatment | | | | | | |
|---|---|---|---|---|---|---|
| (grams active | Yield* | Azoxystrobin % Yield | | IWUE** | Azoxystrobin % IWUE | |
| ingredient/hectare) | (Bu./acre) | Increase | | (Bu./inch) | Increase (Bu./inch) | |
| 1) Azoxystrobin (261 gai/ha) | 217 | +2.4% incr. | +11% incr. | 22.9 | +114% incr. | +40% incr. |
| SDI Chemigated, 50% | | over | over | | over | over |
| Irrigated - DEFICIT\hat{ } | | Untr./100% | Untr./50% | | Untr./100% | Untr./50% |
| | | irr. | Irr. | | irr. | Irr. |
| vs. Control 100% Irrigated | 212 | | | 10.7 | | |
| vs. Control 50% Irrigated | 196 | | | 16.3 | | |
| 2) Azoxystrobin (261 gai/ha) | 211 | +0% incr. over | +11% incr. | 21.1 | +97% incr. | +29% incr. |
| Foliar Applied 50% | | Untr./100% | over | | over | over |
| Irrigated - DEFICIT | | irr. | Untr./50% | | Untr./100% | Untr./50% |
| | | | Irr. | | irr. | Irr. |
| vs. Control 100% Irrigated | 212 | | | 10.7 | | |
| vs. Control 50% Irrigated | 196 | | | 16.3 | | |

*Yield results based on harvested bushels/acre
**Irrigation water use efficiency (IWUE) = bushels per inch of water applied (irrigated yield − rainfed yield)/total irrigation applied)
\hat{ }Deficit - water deficit treatment

### Example 3

Testing Procedure:

A randomized complete block (split plot) study using Subsurface Drip Irrigation (SDI) was conducted on a deep silt loam soil using a 115 day maturity corn hybrid. This trial was conducted to quantify the impact of azoxystrobin on grain yield, and water productivity of corn under limited (deficit) and fully-irrigated setting. The study utilized a subsurface drip irrigation (SDI) system with a nominal dripline flowrate of 0.25 gpm/100 ft for a 5-ft dripline spacing and 24-inch emitter spacing, installed at a depth of 16-18 inches. Irrigation control panels, chemical injection pumps, and filters were housed at the irrigation well house to manage irrigation and chemigation events.

The field study was set up as a randomized complete plot design with three replications on silt loam soil.

Each plot was 8 rows wide (6.1 meters) by 15 meters long. Soil water status was monitored throughout the growing season using soil moisture sensors. Corn seed was planted with a precision planter at a depth of 2 inches and rows spaced at 30 inches. The planting population was 30,000 seeds per acre. Testing parameters, and irrigation levels were conducted according to the Kansas State University experimental procedure [see, e.g.,: (1) Lamm, F. R., A. J. Schlegel, and G. A. Clark. 2003. Development of a Best Management Practice for Nitrogen Fertigation of Corn Using SDI. Appl. Engr in Agric. and (2) Lamm, F. R., H. L. Manges, L. R. Stone, A. H. Khan, and D. H. Rogers. 1995. Water requirement of subsurface drip-irrigated corn in northwest Kansas. Trans. ASAE, 38(2):441-448.]. Moisture levels, irrigation levels, evapotranspiration, and plant health were measured throughout the growing season. Climatic variables were measured (air temperature, rainfall, solar and net radiation, relative humidity, rainfall, wind speed and direction) throughout the season.

Irrigation for the fully irrigated treatments was scheduled according to need by a climatic water budget using calculated evapotranspiration as a withdrawal and with rainfall and irrigation as deposits. Irrigation amounts for each event for the fully irrigated plots were generally 0.5 inches for each event. The deficit irrigation treatments were scheduled at approximately 50% of the fully irrigated plots (4.25 inches/acre vs. 9 inches of water/acre). Volumetric soil water content was measured in one-foot increments to a depth of 8 ft on an approximately weekly basis throughout the crop season to determine total water use. Crop water use was calculated as the sum of irrigation, precipitation and changes in soil water between the initial and final soil water sampling dates. Water productivity (WUE) was calculated as the crop yield divided by the seasonal water use. Maintenance crop protection products were applied as needed to manage weeds and pests throughout the season for all treatments including the control. Azoxystrobin (Quadris) was applied twice by foliar application (tractor mounted sprayer) at 14 fl. oz./acre (261 gai/ha) at approximately the V8 & V8+14da. stage of the corn. Crop yield from each replication was recorded after harvest and adjusted to 15% moisture content. Corn yield components of crop grain yield, plants/area, ears/plant, and kernel weight were measured by hand harvesting a representative sample (20 feet long for one crop row near the center of each subplot).

Results:

No significant differences among treatments, however in the deficit irrigated plots (50% irrigated), Quadris (azoxystrobin) showed a yield increase over the Control deficit treatment and a favorable irrigated water use efficiency (IWUE) value (Table 2). Water use was also significantly different between irrigation and Quadris treatments as might be anticipated since irrigation varied from 4.25 to 9.00 inches.

NOTE: a % increase value of 0% or better vs. the Control at 100% irrigated, shows good activity since the treatment is either equal to or better than the Control using 50% less water.

TABLE 2

| Treatment | | | | IWUE** | | |
|---|---|---|---|---|---|---|
| (grams active | Yield* | | | (lbs./acre | Azoxystrobin % IWUE | |
| ingredient/hectare) | (Bu./acre) | Azoxystrobin % Yield Increase | | in.) | Increase (lbs./inch) | |
| 3) Azoxystrobin (261 gai/ha) | 250 | +0% incr. over | +3% incr. over | 494 | +7% incr. over | +3% incr. over |
| Foliar 50% | | Untr./100% Irr. | Untr./50% Irr. | | Untr./100% Irr. | Untr./50% Irr. |
| Irrigated - DEFICIT\hat{ } | | | | | | |
| vs. Control 100% | 251 | | | 463 | | |
| Irrigated | | | | | | |
| vs. Control 50% Irrigated | 243 | | | 481 | | |

*Yield results based on harvested bushels/acre
**Irrigation water use efficiency (IWUE) or water productivity = pounds per inch of water applied (irrigated yield − rainfed yield)/total irrigation applied)
\hat{ }Deficit - water deficit treatment

### Examples 4-8

Testing Procedure:

A greenhouse subsurface drip irrigation trial was conducted on corn to evaluate treatment effects on yield in fully irrigated vs. deficit irrigated conditions. In this experiment, standardized growth conditions were applied across all corn treatments including: soil-water availability, soil texture and composition, soil chemical and physical properties, meteorological and environmental parameters, and plant nutrition in a greenhouse. No indication of plant disease or pest damage was observed over the course of the study and no pest management program was necessary. A homogeneous sand-organic matter soil mixture (0.18% organic matter) was used as the growth medium in 55-gal containers. These containers were used as a weighing lysimeter, where daily changes in system weight were used to calculate plant transpiration. Four corn plants were grown in each 55-gal container. Three 55-gal containers (12 plants total) made up each treatment. All irrigation and chemical treatments were applied via sub-surface irrigation. Chemical treatments consisted of: azoxystrobin (Quadris), paclobutrazol (Trimmit), trinexapac-ethyl (Moddus), and propiconazole (Tilt) at maximum labeled rates.

Corn plants were grown from seed and transplanted in the 55-gal drums approximately 14 days after planting. Uniform adequate irrigation was applied up to growth stage V3/V4 to ensure plant establishment. Chemical treatment applications were applied at growth stage V3/V4 via sub-surface chemigation. At stage V3/V4, irrigation was decreased to replicate deficit water conditions across all treatments for the remainder of the study period. Irrigation was managed daily to maintain 50% plant-available water. Visual signs of abiotic plant stress were observed approximately 30 days after chemical application. All corn plants were grown to yield and cobs were harvested when kernels were uniformly dry (15% moisture content). Root architecture, specifically relative number of fine roots, was measured at within 2 weeks of harvest using a digital imaging technique. Fine roots are related to water uptake productivity, which is directly tied to the ability of the plant to access soil-water under stress.

Results:

This SDI (subsurface drip) study evaluated Azoxystrobin and 4 other a.i.'s for uptake in corn and how it affects crop health and yield to better evaluate evapotranspiration rates, control water use & plant stress. In a water stress regime (50% irrigated), yield corresponding to Azoxy (azoxystrobin), TXP (trinexapac-ethyl), PPZ (propiconazole) and PBZ (paclobutrazol) was statistically higher than the control (Table 3).

NOTE: a % increase value of 0% or better vs. the Control at 100% irrigated, shows good activity since the treatment is either equal to or better than the Control using 50% less water.

TABLE 3

| Treatment | Yield * | |
|---|---|---|
| (grams active ingredient/hectare) | (Kg/Ha) | % Yield Increase by Product |
| 4) Azoxystrobin (261 gai/ha) SDI Chemigated 50% | 2077† | +12.5% Incr. over Untr./50% Irr. |
| Irrigated-DEFICIT\hat{ } | | |
| vs. Control 50% Irrigated | 1846 | |
| 5) PPZ (126 gai/ha) SDI Chemigated 50% Irrigated- | 1906 | +3.3% Incr. over Untr./50% Irr. |
| DEFICIT | | |
| vs. Control 50% Irrigated | 1846 | |
| 6) TXP (250 gai/ha) SDI Chemigated 50% Irrigated- | 2133† | +15.6% Incr. over Untr./50% Irr. |
| DEFICIT | | |
| vs. Control 50% Irrigated | 1846 | |
| 7) PBZ (12.5 gai/ha) SDI Chemigated 50% Irrigated- | 2152† | +16.6% Incr. over Untr./50% Irr. |
| DEFICIT | | |
| vs. Control 50% Irrigated | 1846 | |
| 8) TMX (70 gai/ha) SDI Chemigated 50% Irrigated- | 1916 | +4% Incr. over Untr./50% Irr. |
| DEFICIT | | |
| vs. Control 50% Irrigated | 1846 | |

* Yield results based on harvested Kg/Ha
\hat{ }Deficit—water deficit treatment
†indicates statistical significance at the 95^{th} percentile confidence interval

### Examples 9-10

Testing Procedure:

A completely random test design (split plot) was conducted using Sprinkler Irrigation. This was an irrigation management test to study treatment effects on yield under full irrigation and deficit irrigation conditions. The field study was set up with four replications and tested on silt loam soil. Overhead sprinkler irrigation and overhead sprinkler chemigation was used in this study. Each plot was 4 rows wide (3 meters) by 9.1 meters long. Soil water status was monitored throughout the growing season using soil moisture sensors. Corn seed was planted with a precision planter at a depth of 2 inches and rows spaced at 30 inches. The planting population was 30,000 seeds per acre. Testing parameters, irrigation levels, and harvesting were conducted according to the University of Nebraska experimental procedure (see, e.g.,: Irmak, S, D. Z. Haman, and R. Bastug. Determination of Crop Water Stress Index for irrigation Timing and Yield Estimation of Corn. 2000. Agronomy Journal. 92:1221-1227). Moisture levels, irrigation levels, and plant health were measured throughout the growing season. Climatic variables were measured (air temperature, rainfall, solar and net radiation, relative humidity, rainfall, wind speed and direction) throughout the season. Irrigation for the fully irrigated treatments was scheduled according crop need based on soil water measurements. The deficit irrigation treatments were scheduled at approximately 60% of the fully irrigated plots (1.2 inches/acre vs. 2 inches of water/acre, respectively). Volumetric soil water content was measured on a weekly basis throughout the crop season to determine total water use. Maintenance crop protection products were applied as needed to manage weeds & pests throughout the season for all treatments including the control. Azoxystrobin (Quadris) was applied via overhead sprinkler irrigation at 261 grams active ingredient/hectare or by foliar application (tractor mounted sprayer) at 261 grams active ingredient/hectare at approximately V6 & R1 stages of the corn. Crop yield from each replication was recorded after harvest and adjusted to 15% moisture content.

Results:

In the deficit irrigated plots (60% irrigated), Quadris (azoxystrobin) showed a yield increase over the Control deficit treatment (Table 4).

NOTE: a % increase value of 0% or better vs. the Control at 100% irrigated, shows good activity since the treatment is either equal to or better than the Control using 40% less water.

TABLE 4

| Treatment | Yield * | | |
|---|---|---|---|
| (grams active ingredient/hectare) | (Bu./acre) | Azoxystrobin % Yield Increase | |
| 9) Azoxystrobin (261 gai/ha) Sprinkler Chemigated 60% | 197 | +5% Incr. | +4% Incr. |
| Irrigated-DEFICIT\hat{ } | | over 100% Untr. | over 60% Untr. |
| vs. Control 100% Irrigated | 188 | | |
| vs. Control 60% Irrigated | 190 | | |
| 10) Azoxystrobin Foliar-applied (261 gai/ha) Applied 60% | 196 | +4% Incr. | +3% Incr. |
| Irrigated-DEFICIT | | over 100% Untr. | over 60% Untr. |
| vs. Control 100% Irrigated | 188 | | |
| vs. Control 60% Irrigated | 190 | | |

* Yield results based on harvested bushels/acre
\hat{ }Deficit—water deficit treatment

### Examples 11-12

Testing Procedure:

A sprinkler irrigation field study was conducted on a deep silt loam soil using a 113 day maturity corn hybrid. This trial was conducted to quantify the impact of azoxystrobin on grain yield, and water productivity of corn under limited (deficit) and fully-irrigated setting. The study utilized a lateral-move sprinkler irrigation (LMS) system. The study was replicated three times in an incomplete block design (ICB). Each plot was approximately 21 meters wide by 30 meters long. Irrigation control panels, chemical injection pumps, and filters were housed at the irrigation well house to manage irrigation and chemigation events.

Soil water status was monitored throughout the growing season using soil moisture sensors. Corn seed was planted with a precision planter at a depth of 2 inches and rows spaced at 30 inches. The planting population was 30,000 seeds per acre. Testing parameters, and irrigation levels were conducted according to the Kansas State University experimental procedure [see, e.g.,: (1) Lamm, F. R., A. J. Schlegel, and G. A. Clark. 2003. Development of a Best Management Practice for Nitrogen Fertigation of Corn Using SDI. Appl. Engr in Agric. and (2) Lamm, F. R., H. L. Manges, L. R. Stone, A. H. Khan, and D. H. Rogers. 1995. Water requirement of subsurface drip-irrigated corn in northwest Kansas. Trans. ASAE, 38(2):441-448.]. Moisture levels, irrigation levels, evapotranspiration, and plant health were measured throughout the growing season. Climatic variables were measured (air temperature, rainfall, solar and net radiation, relative humidity, rainfall, wind speed and direction) throughout the season. Irrigation for the fully irrigated treatments was scheduled according to need by a climatic water budget using calculated evapotranspiration as a withdrawal and with rainfall and irrigation as deposits. Irrigation amounts for each event for the fully irrigated plots were generally 0.96 inches for each event. The deficit irrigation treatments were scheduled at approximately 60% of the fully irrigated plots (6.96 inches/acre vs. 11.76 inches of water/acre). Volumetric soil water content was measured in one-foot increments to a depth of 8 ft on an approximately weekly basis throughout the crop season to determine total water use. Crop water use was calculated as the sum of irrigation, precipitation and changes in soil water between the initial and final soil water sampling dates. Water productivity (WUE) was calculated as the crop yield divided by the seasonal water use. Maintenance crop protection products were applied as needed to manage weeds and pests throughout the season for all treatments including the control.

Azoxystrobin (Quadris) was applied either by sprinkler chemigation at a rate of 261 grams active ingredient/hectare or by foliar application (tractor mounted sprayer) at 261 grams active ingredient/hectare at V6 & R1 growth stages. Crop yield from each replication was recorded after harvest and adjusted to 15% moisture content. Corn yield components of crop grain yield, plants/area, ears/plant, and kernel weight were measured by hand harvesting a representative sample.

Results:

Definitive results were found with Quadris (azoxystrobin) providing yield increases and favourable WUE in a water-deficit situation (Table 5). By reducing water by 40% (water deficit) and applying Quadris via sprinkler chemigation or by foliar application method, a yield increase along with better water productivity was recorded.

NOTE: a % increase value of 0% or better shows good activity since the treatment is either equal to or better than the Control using 40% less water.

TABLE 5

| | | | IWUE** | Azoxystrobin % |
|---|---|---|---|---|
| Treatment | Yield * | Azoxystrobin % | (lbs/acre | IWUE Increase |
| (grams active ingredient/hectare) | (Bu./acre) | Yield Increase | inch) | (lbs./inch) |
| 11) Azoxy Chemigated (261 gai/ha) 60% | 236 | +5% over | 515 | +11% over |
| Irrigated-DEFICIT \hat{ } | | Untr./60% irr. | | Untr./60% irr. |
| vs. Control 60% Irrigated | 224 | | 464 | |
| 12) Azoxy Foliar Applied (261 gai/ha) 60% | 239 | +7% over | 540 | +16% over |
| Irrigated-DEFICIT | | Untr./60% irr. | | Untr./60% irr. |
| vs. Control 60% Irrigated | 224 | | 464 | |

* Yield results based on harvested bushels/acre
**Irrigation water use efficiency (IWUE) (Water Productivity) = pounds of corn per inch of water applied (irrigated yield − rainfed yield)/total irrigation applied)
\hat{ } Deficit—water deficit treatment

### Examples 13-14

Testing Procedure:

A randomized complete block (split plot) study using Subsurface Drip Irrigation (SDI) was conducted on a deep silt loam soil using a 113 day maturity corn hybrid. This trial was conducted to quantify the impact of treatments on grain yield and water productivity of corn under limited (deficit) and fully-irrigated setting. The study utilized a subsurface drip irrigation (SDI) system with a nominal dripline flowrate of 0.25 gpm/100 ft for a 5-ft dripline spacing and 24-inch emitter spacing, installed at a depth of 16-18 inches. Irrigation control panels, chemical injection pumps, and filters were housed at the irrigation well house to manage irrigation and chemigation events.

The field study was set up as a randomized complete plot design with three replications on silt loam soil.

Each plot was 8 rows wide (6.1 meters) by 15 meters long. Soil water status was monitored throughout the growing season using soil moisture sensors. Corn seed was planted with a precision planter at a depth of 2 inches and rows spaced at 30 inches. The planting population was 30,000 seeds per acre. Testing parameters, and irrigation levels were conducted according to the Kansas State University experimental procedure [see, e.g.,: (1) Lamm, F. R., A. J. Schlegel, and G. A. Clark. 2003. Development of a Best Management Practice for Nitrogen Fertigation of Corn Using SDI. Appl. Engr in Agric. and (2) Lamm, F. R., H. L. Manges, L. R. Stone, A. H. Khan, and D. H. Rogers. 1995. Water requirement of subsurface drip-irrigated corn in northwest Kansas. Trans. ASAE, 38(2):441-448.]. Moisture levels, irrigation levels, evapotranspiration, and plant health were measured throughout the growing season. Climatic variables were measured (air temperature, rainfall, solar and net radiation, relative humidity, rainfall, wind speed and direction) throughout the season.

Irrigation for the fully irrigated treatments was scheduled according to need by a climatic water budget using calculated evapotranspiration as a withdrawal and with rainfall and irrigation as deposits. Irrigation amounts for each event for the fully irrigated plots were generally 0.5 inches for each event. The deficit irrigation treatments were scheduled at approximately 50% of the fully irrigated plots (5.9 inches/acre vs. 13.55 inches of water/acre). Volumetric soil water content was measured in one-foot increments to a depth of 8 ft on an approximately weekly basis throughout the crop season to determine total water use. Crop water use was calculated as the sum of irrigation, precipitation and changes in soil water between the initial and final soil water sampling dates. Water productivity was calculated as the crop yield divided by the seasonal water use. Maintenance crop protection products were applied as needed to manage weeds and pests throughout the season for all treatments including the control. Moddus (trinexapac-ethyl) was foliar-applied (tractor mounted sprayer) twice at a rate of 250 gai/ha at approximately the V3+V7 stages of the corn. Azoxystrobin (Quadris) was applied twice via drip irrigation at a rate of 0.8 fl. oz/1000 linear ft (261 gai/ha) at approximately V6 & R1 stages of the corn. Crop yield from each replication was recorded after harvest and adjusted to 15% moisture content. Corn yield components of crop grain yield, plants/area, ears/plant, and kernel weight were measured by hand harvesting a representative sample (20 feet long for one crop row near the center of each subplot).

Definitive results were found with Moddus (trinexapac-ethyl) providing yield increases in a water-deficit situation (Table 6). Additionally, a 28% increase in water productivity was realized with Moddus.

NOTE: a % Increase value of 0% or better shows good activity since the treatment is either equal to or better than the Control using 50% less water.

TABLE 6

| | | | | % increase in Water |
|---|---|---|---|---|
| Treatment | Yield * | % Yield Increase | Water | Productivity by |
| (grams active ingredient/hectare) | (Bu./acre) | by Product | Prodctivity** | Product |
| 13) Moddus (Trinexapac-ethyl) (250 gai/ha), | 235 | +28% Incr. over | 462 | +28% Incr. |
| foliar-applied at 50% Irrigated-DEFICIT\hat{ } | | Untr./50% irr. | | over 50% irr. |
| vs. Control 50% Irrigated | 183 | | 361 | |
| 14) Azoxystrobin (261 gai/ha), SDI | 212\hat{ } | +16% Incr. over | 426 | +18% Incr. |
| chemigated at 50% Irrigated-DEFICIT\hat{ } | | Untr./50% irr. | | over 50% irr. |
| vs. Control 50% Irrigated | 183 | | 361 | |

* Yield results based on harvested bushels/acre
**Water Productiviy (IWUE) = pounds of corn per inch of water applied
\hat{ }Deficit—water deficit treatment

### Examples 15-16

Testing Procedure:

A chemigation study using Subsurface Drip Irrigation (SDI) was conducted to quantify the impact of azoxystrobin on grain yield, evapotranspiration, and water use efficiency of corn under dryland/rainfed conditions. The field study was set up as a randomized complete plot design (split plot) with three replications on silt loam soil. Each plot was 8 rows wide (6.1 meters) by 34 meters long. Soil water status was monitored on an hourly basis every 30 cm up to 1.2 meters throughout the growing season using soil moisture sensors. Corn seed was planted with a precision planter at a depth of 2 inches and rows spaced at 30 inches. The planting population was 30,000 seeds per acre. Testing parameters, irrigation levels, and harvesting were conducted according to the University of Nebraska experimental procedure (see, e.g.,: Irmak, S, D. Z. Haman, and R. Bastug. Determination of Crop Water Stress Index for irrigation Timing and Yield Estimation of Corn. 2000. Agronomy Journal. 92:1221-1227). Moisture levels, evapotranspiration, and plant health were measured throughout the growing season. All microclimatic variables were measured (air temperature, rainfall, solar and net radiation, relative humidity, rainfall, wind speed and direction) so that the researcher could quantify the range of the microclimatic conditions under which this research was conducted to define the boundaries of experimental conditions.

Field management consisted of three irrigation treatments: 100% ETc, 50% ETc, and rainfed (ETc=actual crop evapotranspiration). No irrigation was applied on rainfed plots. Fertility management included 190 lbs/acre of 28% UAN was applied early season. Maintenance crop protection products were applied as needed to manage weeds and pests throughout the season for all treatments including the control. Azoxystrobin (Quadris) was applied twice via drip irrigation at a rate of 0.8 fl. oz/1000 linear ft (261 gai/ha) or by foliar application (tractor mounted sprayer) at 14 fl. oz./acre (261 gai/ha) at approximately the V6 & R1 stage of the corn. Crop yield from each replication was recorded after harvest and adjusted to 15.5% moisture content. The researcher developed ETc vs. yield relationships (crop water production functions) for different treatments to evaluate the product impact on these functions. Quantified crop water use efficiency (CWUE) from ETc, dryland yield, and irrigated yield data was calculated to evaluate the product impact on CWUE.

Results:

Definitive results were found with Quadris (Azoxystrobin) providing yield increases and favourable CWUE in a 0% irrigated, dryland situation (Table 7).

NOTE: a % increase value of 0% or better shows good activity since the treatment is either equal to or better than the Control using 0% water.

TABLE 7

| Treatment | Yield * | Azoxystrobin % | CWUE** | Azoxystrobin % |
|---|---|---|---|---|
| (grams active ingredient/hectare) | (Bu./acre) | Yield Increase | (Bu./inch) | CWUE Increase |
| 15) Azoxystrobin (261 gai/ha) SDI | 166.2 | +9.6% incr over | 1.125 | +142% incr over |
| Chemigated, 0% Irrigated-DEFICIT\hat{ } | | Untr./0% irr. | | Untr./0% irr. |
| (rainfed/dryland) | | | | |
| vs. Control 0% Irrigated/dryland or rainfed | 151.6 | | 0.464 | |
| 16) Azoxystrobin (261 gai/ha) Foliar Applied | 161.8 | +6.7% incr over | 0.965 | +108% incr over |
| 0% Irrigated-DEFICIT\hat{ } (rainfed/dryland) | | Untr./0% irr. | | Untr./0% irr. |
| vs. Control 0% Irrigated/dryland or rainfed | 151.6 | | 0.464 | |

* Yield results based on harvested bushels/acre
**Crop water use efficiency (CWUE) = bushels per inch of water available (irrigated yield − rainfed yield/ET)
\hat{ }Deficit—no irrigation, dryland

### Examples 17-19

Testing Procedure:

A chemigation study using Subsurface Drip Irrigation (SDI) was conducted to quantify the impact of treatment effects on grain yield under rainfed conditions. The field study was set up as a randomized complete plot design (split plot) with three replications on silt loam soil. Each plot was 8 rows wide (6.1 meters) by 34 meters long. Soil water status was monitored on an hourly basis every 30 cm up to 1.2 meters throughout the growing season using soil moisture sensors. Corn seed was planted with a precision planter at a depth of 2 inches and rows spaced at 30 inches. The planting population was 30,000 seeds per acre. Testing parameters and harvesting were conducted according to the University of Nebraska experimental procedure (see, e.g.,: Irmak, S, D. Z. Haman, and R. Bastug. Determination of Crop Water Stress Index for irrigation Timing and Yield Estimation of Corn. 2000. Agronomy Journal. 92:1221-1227). Moisture levels, evapotranspiration, and plant health were measured throughout the growing season. All microclimatic variables were measured (air temperature, rainfall, solar and net radiation, relative humidity, rainfall, wind speed and direction) so that the researcher could quantify the range of the microclimatic conditions under which this research was conducted to define the boundaries of experimental conditions.

No irrigation was applied to rainfed plots. Fertility management included 190 lbs/acre of 28% UAN was applied early season. Maintenance crop protection products were applied as needed to manage weeds and pests throughout the season for all treatments including the control. Azoxystrobin (Quadris) was applied twice via drip irrigation at a rate of 0.8 fl. oz/1000 linear ft (261 gai/ha) or by foliar application (tractor mounted sprayer) at 14 fl. oz./acre (261 gai/ha) at approximately the V6 & R1 stages of the corn. Moddus (trinexapac-ethyl) was foliar-applied (tractor mounted sprayer) once at a rate of 250 gai/ha at approximately the V7 stage of the corn. Crop yield from each replication was recorded after harvest and adjusted to 15.5% moisture content.

Results:

Definitive results were found with Quadris (Azoxystrobin) providing yield increases under rainfed/dryland conditions (Table 8).

NOTE: a % increase value of 0% or better shows good activity since the treatment is either equal to or better than the Control using 0% water.

TABLE 8

| Treatment | Yield * | % Yield Increase by |
|---|---|---|
| (grams active ingredient/hectare) | (Bu./acre) | Product |
| 17) Azoxystrobin (261 gai/ha) SDI Chemigated, 0% Irrigated- | 145.4 | +7% incr over Untr./0% irr. |
| DEFICIT\hat{ } (dryland/rainfed) | | |
| vs. Control 0% Irrigated/dryland or rainfed | 135.9 | |
| 18) Azoxystrobin (261 gai/ha) Foliar Applied 0% Irrigated- | 151.1 | +11% incr over Untr./0% irr. |
| DEFICIT\hat{ } (dryland/rainfed) | | |
| vs. Control 0% Irrigated/dryland or rainfed | 135.9 | |
| 19) Moddus (250 gai/ha) Foliar Applied 0% Irrigated-DEFICIT | 141.9 | +4% incr over Untr./0% irr. |
| vs. Control 0% Irrigated/dryland or rainfed | 135.9 | |

* Yield results based on harvested bushels/acre and based on optimum nitrogen rate (200 lbs. N/acre)
** Crop water use efficiency (CWUE) was not calculated by researcher in 2010
\hat{ }Deficit—no irrigation, dryland

### Examples 20-23

In this experiment, standardized growth conditions were applied across all corn treatments including: soil-water availability, soil texture and composition, soil chemical and physical properties, meteorological and environmental parameters, and plant nutrition in a greenhouse. No indication of plant disease or pest damage was observed over the course of the study and no pest management program was necessary. A homogeneous sand-organic matter soil mixture (0.18% organic matter) was used as the growth medium in 55-gal containers. These containers were used as a weighing lysimeter, where daily changes in system weight were used to calculate plant transpiration. Four corn plants were grown in each 55-gal container. Three 55-gal containers (12 plants total) made up each treatment. All irrigation and chemical treatments were applied via sub-surface irrigation. Chemical treatments consisted of: azoxystrobin (Quadris), paclobutrazol (Trimmit), trinexapac-ethyl (Moddus), and propiconazole (Tilt) at maximum labeled rates.

Corn plants were grown from seed and transplanted in the 55-gal drums approximately 14 days after planting. Uniform adequate irrigation was applied up to growth stage V3/V4 to ensure plant establishment. Chemical treatment applications were applied at growth stage V3/V4 via sub-surface chemigation. At stage V3/V4, irrigation was decreased to replicate deficit water conditions across all treatments for the remainder of the study period. Irrigation was managed daily to maintain 50% plant-available water. Visual signs of abiotic plant stress were observed approximately 30 days after chemical application. All corn plants were grown to yield and cobs were harvested when kernels were uniformly dry (15% moisture content). Root architecture, specifically relative number of fine roots, was measured at within 2 weeks of harvest using a digital imaging technique. Fine roots are related to water uptake productivity, which is directly tied to the ability of the plant to access soil-water under stress.

### Results

Effects of the chemical treatments via sub-surface irrigation on yield and root architecture were specifically documented. The effects are herein reported as the percentage increase compared to the untreated check (12 plants in three containers). As shown in Table 9, all chemigated products under abiotic stress improved yield compared to the untreated check (UTC) by between 3.3 and 16.6% (variability within each treatment was less than 20%). Azoxystrobin, paclobutrazol, and trinexapac-ethyl were statistically different from the control (P values: <0.001 at the 95^{th} percentile confidence interval). Similarly, relative number of fine roots for the four treatments were significantly different from the UTC, suggesting that the ability of plants treated with these compounds would be more biologically equipped to access soil-water under abiotic water stress. This is supported by the yield data that showed improved production under abiotic water stress.

TABLE 9
Yield and root architecture results.

| | | Relative number |
|---|---|---|
| | Yield | of fine roots |
| | (% difference | (% difference |
| Treatment | from UTC) | from UTC) |
| 20-Azoxystrobin | 12.5† | 37.3† |
| 21-Paclobutrazol | 16.6† | 70.0† |
| 22-Trinexapac-ethyl | 15.6† | 34.3† |
| 23-Propiconazole | 3.3 | 39.4† |

†indicates statistical significance at the 95^{th} percentile confidence interval

### Examples 24-25

Testing Procedure: A sprinkler irrigation field study was conducted on a deep silt loam soil using a 112 day maturity corn hybrid. This trial was conducted to quantify the impact of azoxystrobin and trinexapac-ethyl on grain yield, and water productivity of corn under limited (deficit) and fully-irrigated settings. The study utilized a lateral-move sprinkler irrigation (LMS) system. The study was replicated three times in an incomplete complete block design (ICB). Each main plot was approximately 185 sq. meters. Irrigation control panels, chemical injection pumps, and filters were housed at the irrigation well house to manage irrigation and chemigation events.

Soil water status was monitored throughout the growing season using soil moisture sensors. Corn seed was planted with a precision planter at a depth of 2 inches and rows spaced at 30 inches. The planting population was 30,000 seeds per acre. Testing parameters, and irrigation levels were conducted according to the Kansas State University experimental procedure [see e.g., (1) Lamm, F. R., A. J. Schlegel, and G. A. Clark. 2003. Development of a Best Management Practice for Nitrogen Fertigation of Corn Using SDI. Appl. Engr in Agric. and (2) Lamm, F. R., H. L. Manges, L. R. Stone, A. H. Khan, and D. H. Rogers. 1995. Water requirement of subsurface drip-irrigated corn in northwest Kansas. Trans. ASAE, 38(2):441-448.]. Moisture levels, irrigation levels, evapotranspiration, and plant health were measured throughout the growing season. Climatic variables were measured (air temperature, rainfall, solar and net radiation, relative humidity, rainfall, wind speed and direction) throughout the season. Irrigation for the fully irrigated treatments was scheduled according to need by a climatic water budget using calculated evapotranspiration as a withdrawal and with rainfall and irrigation as deposits. Irrigation amounts for each event for the fully irrigated plots were generally 0.96 inches for each event. The deficit irrigation treatments were scheduled at approximately 60% of the fully irrigated plots. Volumetric soil water content was measured in one-foot increments to a depth of 8 ft on an approximately weekly basis throughout the crop season to determine total water use. Crop water use was calculated as the sum of irrigation, precipitation and changes in soil water between the initial and final soil water sampling dates. Water productivity (WUE) was calculated as the crop yield divided by the seasonal water use (Water Productivity (WP)=Yield/ETc). ETc is the total crop water use (ETc) from soil water balance. Maintenance crop protection products were applied as needed to manage weeds and pests throughout the season for all treatments including the control. Azoxystrobin+propiconazole was applied either by sprinkler chemigation at a rate of 261 grams active ingredient/hectare or by foliar application (tractor mounted sprayer) at 261 grams active ingredient/hectare at V5 & R1 growth stages. Crop yield from each replication was recorded after harvest and adjusted to 15% moisture content. Corn yield components of crop grain yield, plants/area, ears/plant, and kernel weight were measured by hand harvesting a representative sample.

Results: Definitive results were found with a combination of products providing yield increases and favourable water productivity in a water-deficit situation (Table xx), including Azoxy (azoxystrobin), TXP (trinexapac-ethyl), PPZ (propiconazole). By reducing water by 40% (water deficit) and applying by foliar application method, a yield increase along with better water productivity was recorded.

NOTE: With reference to the 60% irrigated, a % increase value of 0% or better shows good activity since the treatment is either equal to or better than the Control using 40% less water.

TABLE 10

| | | | IWUE** | % IWUE |
|---|---|---|---|---|
| Treatment | Yield * | | (lbs/acre | Increase |
| (grams active ingredient/hectare) | (Bu./acre) | % Yield Increase | inch) | (lbs./acre-inch) |
| 24) TXP (250 gai/ha) 60% Irrigated- | 209 | +3.5% over | 484 | +5% over |
| DEFICIT \hat{ } | | Untr./60% irr. | | Untr./60% irr. |
| vs. Control 60% Irrigated | 202 | | 463 | |
| 25) Azoxy Foliar Applied (261 gai/ha) + PPZ | 216 (b) | +6.4% over | 476 | +5 % over |
| (126 gai/ha) 60% & 100% Irrigated | | Untreated | | Untreated |
| vs. Control 60% & 100% Irrigated | 203 (a) | | 454 | |

* Yield results based on harvested bushels/acre; means followed by different letters (a, b) are statistically different
**Irrigation water use efficiency (IWUE) (Water Productivity) = pounds of corn per acre inch of water applied (irrigated yield − rainfed yield)/total irrigation applied)
\hat{ } Deficit—water deficit treatment

### Examples 26

Testing Procedure:

A completely random test design (split plot) was conducted using Sprinkler Irrigation. This was an irrigation management test to study treatment effects on yield under full irrigation and deficit irrigation conditions. The field study was set up with four replications and tested on silt loam soil. Overhead sprinkler irrigation and overhead sprinkler chemigation was used in this study. Each plot was 8 rows (row width=2.5 ft.) wide (20 ft.) by 60 ft. long. Soil water status was monitored throughout the growing season using soil moisture sensors. Corn seed was planted with a precision planter at a depth of 2 inches and rows spaced at 30 inches. The planting population was 30,000 seeds per acre. Testing parameters, irrigation levels, and harvesting were conducted according to the University of Nebraska experimental procedure [see e.g., (1) Irmak, S, D. Z. Haman, and R. Bastug. Determination of Crop Water Stress Index for irrigation Timing and Yield Estimation of Corn. 2000. Agronomy Journal. 92:1221-1227. and (2) Payero, et. al. 2006. Yield response of corn to deficit irrigation in a semiarid climate. Agricultural Water Management vol. 846: 101-112].

Moisture levels, irrigation levels, and plant health were measured throughout the growing season. Climatic variables were measured (air temperature, rainfall, solar and net radiation, relative humidity, rainfall, wind speed and direction) throughout the season. Irrigation for the fully irrigated treatments was scheduled according crop need based on soil water measurements. The deficit irrigation treatments were scheduled at approximately 60% of the fully irrigated plots (1.2 inches/acre vs. 2 inches of water/acre, respectively). Volumetric soil water content was measured on a weekly basis throughout the crop season to determine total water use. Maintenance crop protection products were applied as needed to manage weeds & pests throughout the season for all treatments including the control. Azoxystrobin (Quadris) and Azoxystrobin+Propiconazole (Quilt Xcel) at 261 g+126 g ai/hectare, respectively, was applied via overhead sprinkler irrigation or by foliar application (tractor mounted sprayer) at V5 & R1 stages of the corn. Crop yield from each replication was recorded after harvest and adjusted to 15% moisture content.

Results:

In the deficit irrigated plots (60% irrigated), Quilt (azoxystrobin+propiconazole) showed a yield increase over the Control deficit treatment (Table 11).

NOTE: With reference to the 60% irrigated, a % increase value of 0% or better vs. the Control at 100% irrigated, shows good activity since the treatment is either equal to or better than the Control using 40% less water.

TABLE 11

| | | | | Water | % IWUE |
|---|---|---|---|---|---|
| | | | | Productivity | Increase |
| Treatment | Yield * | Azoxystrobin % Yield | | (bushels/acre | (bu./acre- |
| (grams active ingredient/hectare) | (Bu./acre) | Increase | | inch)** | inch) |
| 26) Azoxystrobin + Propiconazole (261 g + | 238\hat{ }\hat{ } | +8% Incr. | +8% Incr. | 10.6 | +8% Incr. |
| 126 g ai/ha rate) Foliar-applied at 60% | | over 100% | over 60% | | over 60% |
| Irrigated-DEFICIT\hat{ } | | Untreated | Untreated | | Untreated |
| vs. Control 100% Irrigated | 221 | | | 9.2 | |
| vs. Control 60% Irrigated | 220.8 | | | 9.8 | |

* Yield results based on harvested bushels/acre
**Irrigation water use efficiency (IWUE) (Water Productiv iy) = bushels of corn per acre inch of water applied (irrigated yield − rainfed yield)/total irrigation applied)
\hat{ }Deficit—water deficit treatment
\hat{ }\hat{ }statistically significant at 5% significance level

### Examples 27-28

Testing Procedure: The overall objective was to conduct an irrigation management test to study the effects of fungicides and crop enhancement products on yield, WUE, and disease control under full irrigation and deficit irrigation conditions. This was a sprinkler irrigation field study conducted on a deep silt loam soil. The test was set up to specifically quantify the impact of azoxystrobin and acibenzolar-S-methyl on soybean yield and water productivity of soybean under limited (deficit) and fully-irrigated settings. The study utilized a sprinkler irrigation system. The study was replicated three times in an incomplete complete block design (ICB). Irrigation control panels, chemical injection pumps, and filters were housed at the irrigation well house to manage irrigation and chemigation events.

Soil water status was monitored throughout the growing season using soil moisture sensors. Soybean variety NK S31-L7 was planted on May 11, 2011 at the rate of 150,000 seed per acre. Testing parameters, and irrigation levels were conducted according to the University of Nebraska experimental procedure [see e.g., (1) Irmak, et. al.] Moisture levels, irrigation levels, evapotranspiration, and plant health were measured throughout the growing season. Climatic variables were measured (air temperature, rainfall, solar and net radiation, relative humidity, rainfall, wind speed and direction) throughout the season. Irrigation for the fully irrigated treatments was scheduled according to need by a climatic water budget using calculated evapotranspiration as a withdrawal and with rainfall and irrigation as deposits. Irrigation amounts for each event for the fully irrigated plots were generally 0.96 inches for each event. The deficit irrigation treatments were scheduled at approximately 60% of the fully irrigated plots. Volumetric soil water content was measured in one-foot increments to a depth of 8 ft on an approximately weekly basis throughout the crop season to determine total water use. Crop water use was calculated as the sum of irrigation, precipitation and changes in soil water between the initial and final soil water sampling dates. Water productivity (WUE) was calculated as the crop yield divided by the seasonal water use (Water Productivity (WP)=Yield/ETc). ETc is the total crop water use (ETc) from soil water balance. Maintenance crop protection products were applied as needed to manage weeds and pests throughout the season for all treatments including the control

Results:

A significant difference in yield was recorded with Actigard at 60% Irrigation (deficit).

NOTE: With reference to the 60% irrigated, a % increase value of 0% or better shows good activity since the treatment is either equal to or better than the Control using 40% less water.

TABLE 12

| Treatment | Yield * | |
|---|---|---|
| (grams active ingredient/hectare) | (Bu./acre) | % Yield Increase |
| 27) Acibenzolar-S-methyl (10 gai/ha) 60% Irrigated-DEFICIT\hat{ } | 53.1 | +1% over Untr./60% irr. |
| vs. Control 60% Irrigated | 52.7 | |
| 28) Azoxy (Foliar applied) (150 gai/ha) + Acibenzolar-S-methyl | 55.4 | +6% over Untreated/60% irr. |
| (10 gai/ha) 60% Irrigated-DEFICIT \hat{ } | | |
| vs. Control 60% Irrigated | 52.4 | |

* Yield results based on harvested bushels/acre
\hat{ } Deficit—water deficit treatment

### Examples 29-30

Testing Procedure: The overall objective was to conduct an irrigation management test to study the effects of fungicides and crop enhancement products on yield, WUE, and disease control under full irrigation and deficit irrigation conditions. This was a sprinkler irrigation field study conducted on a deep silt loam soil. The test was set up to specifically quantify the impact of azoxystrobin and acibenzolar-S-methyl on soybean yield and water productivity of soybean under limited (deficit) and fully-irrigated settings. The study utilized a lateral-move sprinkler irrigation (LMS) system. The study was replicated three times in an incomplete complete block design (ICB). Irrigation control panels, chemical injection pumps, and filters were housed at the irrigation well house to manage irrigation and chemigation events.

Soil water status was monitored throughout the growing season using soil moisture sensors. Soybean variety NK S31-L7 was planted at the rate of 150,000 seed per acre. Testing parameters, and irrigation levels were conducted according to the Kansas State University experimental procedure [see e.g., (1) Lamm, F. R., A. J. Schlegel, and G. A. Clark. 2003. Moisture levels, irrigation levels, evapotranspiration, and plant health were measured throughout the growing season. Climatic variables were measured (air temperature, rainfall, solar and net radiation, relative humidity, rainfall, wind speed and direction) throughout the season. Irrigation for the fully irrigated treatments was scheduled according to need by a climatic water budget using calculated evapotranspiration as a withdrawal and with rainfall and irrigation as deposits. Irrigation amounts for each event for the fully irrigated plots were generally 0.96 inches for each event. The deficit irrigation treatments were scheduled at approximately 60% of the fully irrigated plots. Volumetric soil water content was measured in one-foot increments to a depth of 8 ft on an approximately weekly basis throughout the crop season to determine total water use. Crop water use was calculated as the sum of irrigation, precipitation and changes in soil water between the initial and final soil water sampling dates. Water productivity (WUE) was calculated as the crop yield divided by the seasonal water use (Water Productivity (WP)=Yield/ETc). ETc is the total crop water use (ETc) from soil water balance. Maintenance crop protection products were applied as needed to manage weeds and pests throughout the season for all treatments including the control.

Results: An increase in water productivity was recorded with both azoxystrobin and acibenzolar-S-methyl treatments. Statistically significant difference in seed mass was recorded with all Quadris treatments.

NOTE: With reference to the 60% irrigated, a % increase value of 0% or better shows good activity since the treatment is either equal to or better than the Control using 40% less water.

TABLE 13

| | | | IWUE** | % IWUE | | % Seed |
|---|---|---|---|---|---|---|
| Treatment | Yield* | % Yield | (lbs/acre- | Increase | Seed Mass | Mass |
| (grams active ingredient/hectare) | (Bu./acre) | Increase | inch) | (lbs./acre-inch) | (mg) | Increase |
| 29) One application of Azoxy | 48.4 | +2% over | 129 | +2% over | 148a | +3% over |
| Foliar Applied (150 gai/ha)- | | Untreated | | Untreated | | Untreated |
| average of 60% & 100% Irrigated | | | | | | |
| vs. Control 60% & 100% Irrigated | 47.5 | | 126 | | 143b | |
| 30) Two applications of Azoxy | 49.7 | +5% over | 133 | +6% over | 151a | +6% over |
| Foliar Applied (150 gai/ha)- | | Untreated | | Untreated | | Untreated |
| average of 60% & 100% Irrigated | | | | | | |
| vs. Control 60% & 100% Irrigated | 47.5 | | 126 | | 143b | |

*Yield results based on harvested bushels/acre; means followed by different letters (a, b) are statistically different
**Irrigation water use efficiency (IWUE) (Water Productivity) = pounds of soybean per acre inch of water applied (irrigated yield − rainfed yield)/total irrigation applied)

### Examples 29-30

Testing Procedure:

The overall objective was to conduct an irrigation management test to study the effects of fungicides and crop enhancement products on yield, WUE, and disease control under full irrigation and deficit irrigation conditions. This was a sprinkler irrigation field study conducted on a deep silt loam soil. The test was set up to specifically quantify the impact of azoxystrobin and acibenzolar-S-methyl on soybean yield and water productivity of soybean under limited (deficit) and fully-irrigated settings. The study utilized a sprinkler irrigation system. The study was replicated three times in an incomplete complete block design (ICB). Irrigation control panels, chemical injection pumps, and filters were housed at the irrigation well house to manage irrigation and chemigation events.

Soil water status was monitored throughout the growing season using soil moisture sensors. Soybean variety NK S31-L7 was planted at the rate of 150,000 seed per acre. Testing parameters, and irrigation levels were conducted according to the University of Nebraska experimental procedure [see e.g., (1) Irmak, et. al.] Moisture levels, irrigation levels, evapotranspiration, and plant health were measured throughout the growing season. Climatic variables were measured (air temperature, rainfall, solar and net radiation, relative humidity, rainfall, wind speed and direction) throughout the season. Irrigation for the fully irrigated treatments was scheduled according to need by a climatic water budget using calculated evapotranspiration as a withdrawal and with rainfall and irrigation as deposits. Irrigation amounts for each event for the fully irrigated plots were generally 0.96 inches for each event. The deficit irrigation treatments were scheduled at approximately 60% of the fully irrigated plots. Volumetric soil water content was measured in one-foot increments to a depth of 8 ft on an approximately weekly basis throughout the crop season to determine total water use. Crop water use was calculated as the sum of irrigation, precipitation and changes in soil water between the initial and final soil water sampling dates. Water productivity (WUE) was calculated as the crop yield divided by the seasonal water use (Water Productivity (WP)=Yield/ETc). ETc is the total crop water use (ETc) from soil water balance. Maintenance crop protection products were applied as needed to manage weeds and pests throughout the season for all treatments including the control. Azoxystrobin was applied either by sprinkler chemigation or by foliar application (tractor mounted sprayer.

Results:

Azoxystrobin foliar (2 applications) at 60% & 100% irrigated showed significant differences in yield. Acibenzolar-S-methyl also showed differences in yield over the untreated. Good WUE differences with azoxystrobin and acibenzolar-S-methyl, in a water deficit regime, was recorded.

NOTE: With reference to the 60% irrigated, a % increase value of 0% or better shows good activity since the treatment is either equal to or better than the Control using 40% less water.

TABLE 14

| | | | | WUE | |
|---|---|---|---|---|---|
| | | | | (bushels/ | % WUE |
| Treatment | Yield * | Treatment | | acre- | Increase |
| (grams active ingredient/hectare) | (Bu./acre) | % Yield Increase | | inch)** | (bu./acre-inch) |
| 31) Azoxy (150 gai/ha) | 72 | +11% Incr. | +6% Incr. | 4.1 | 11% Increase |
| (Foliar applied, 2 applications) | | over 100% | over 60% | | over the 100% |
| 60% Irrigated-DEFICIT \hat{ } | | Untreated | Untreated | | irrigated Control |
| vs. Control 100% Irrigated | 65 | | | 3.7 | |
| vs. Control 60% Irrigated | 68 | | | 3.9 | |
| 32) Azoxy (150 gai/ha) (Foliar applied, 2 | 74\hat{ }\hat{ } | +14% Incr. | +9% Incr. | 4.2 | 14% Increase |
| apps) + Acibenzolar-S-methyl (10 gai/ha) | | over 100% | over 60% | | over the 100% |
| 60% Irrigated-DEFICIT \hat{ } | | Untreated | Untreated | | irrigated Control |
| vs. Control 100% Irrigated | 65 | | | 3.7 | |
| vs. Control 60% Irrigated | 68 | | | 3.9 | |

* Yield results based on harvested bushels/acre
**water use efficiency (WUE) (Water Productivity) = bushels of corn per acre inch of water applied (irrigated yield − rainfed yield)/total irrigation applied)
\hat{ } Deficit—water deficit treatment;
\hat{ }\hat{ } statistically significant difference

In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

What is claimed is:

1. A method of improving the yield in crops of useful plants managed for water-deficit conditions during a growing period comprising the steps of:
a) determining an expected non-deficit water requirement for the crop for the growing period(s) to be managed;
b) maintaining water-deficit conditions relative to the expected requirement during the growing period(s) being managed;
c) applying to the crop plant, parts of such plant, plant propagation material, or at its locus of growth, a yield improving effective amount of at least one compound selected from azoxystrobin, thiamethoxam, propiconazole, paclobutrazole, acibenzolar-S-methyl and trinexapac-ethyl.

2. The method according to claim 1, wherein said agrochemical compound is applied to the foliage of the plant.

3. The method according to claim 1, wherein said agrochemical compound is applied to the locus of the plant.

4. The method according to claim 1, wherein said agrochemical compound is applied in the irrigation water.

5. The method according to claim 1, wherein said water-deficit is managed by irrigation.

6. The method according to claim 5, wherein said irrigation water is sprinkler applied.

7. The method according to claim 5, wherein said irrigation water is sub surface drip or drip applied.

8. The method according to claim 1, wherein said growing period comprises one or more vegetative growth periods.

9. The method according to claim 1, wherein said growing period comprises one or more reproductive growth periods.

10. The method according to claim 1, wherein said growing period comprises the entire growing season.

11. The method according to claim 1, wherein the crop available water is maintained at an average of from 40 to 80% of the expected requirement for the growing period being managed under water-deficit conditions.

12. The method according to claim 11, wherein the crop available water is maintained at an average of from 50 to 75% of the expected requirement for the growing period being managed under water-deficit conditions.

13. The method according to claim 1, wherein said increased yield is manifested as one or more of: increased total number of seeds, increased number of filled seeds, increased total seed yield, increased root length or increased root diameter, each relative to a corresponding control plant grown under optimal water conditions.

14. The method according to claim 1, wherein the crop is selected from corn and soybean.

15. The method according to claim 1, wherein the crops of useful plants are cultivated in a soil selected from clay, clay loam, loam, loamy sand, sand, sandy clay, sandy clay loam, silt, silty clay, silty clay loam and silt loam.

16. A method of improving the water use efficiency in crops of useful plants managed for water-deficit conditions during a growing period comprising the steps of:
a) determining an expected non-deficit water requirement for the crop for the growing period(s) to be managed;
b) maintaining water-deficit conditions relative to the expected requirement during the growing period(s) being managed;;
c) applying to the plant, parts of such plant, plant propagation material, or at its locus of growth, a water use efficiency improving effective amount of at least one compound selected from azoxystrobin, thiamethoxam, propiconazole, paclobutrazole, acibenzolar-S-methyl and trinexapac-ethyl.

17. The method according to claim 16, wherein said agrochemical compound is applied to the foliage of the plant.

18. The method according to claim 16, wherein said agrochemical compound is applied to the locus of the plant.

19. The method according to claim 16, wherein said agrochemical compound is applied in the irrigation water.

20. The method according to claim 16, wherein said water-deficit is managed by irrigation.

21. The method according to claim 20, wherein said irrigation water is sprinkler applied.

22. The method according to claim 20, wherein said irrigation water is sub surface drip or drip applied.

23. The method according to claim 16, wherein said water use efficiency (WUE) is measured by at least one formula selected from:
WUE=Yield/Evapotranspiration;
mass of grain/water volume); and
(irrigated yield−rainfed yield)/(Evapotranspriation or total irrigation applied.

24. The method according to claim 16, wherein the crop is selected from corn and soybean.
